(19) United States
(12) Patent Application Publication
(10) Pub. No.: US 2001/0055213 A1
(43) Pub. Date: Dec. 27, 2001

(54) ILLUMINATED DISPLAY WITH EL ELEMANT(S)

(76) Inventor: TSENG-LU CHIEN, TAIPEI HSENG (TW)

Correspondence Address: HOWARD C. MISKIN, C/O STOLL, MISKIN, HOFFMAN & BADIE, EMPIRE STATE BUILDING, 350 FIFTH AVE., STE. 6110, NEW YORK, NY, 10118, US

(21) Appl. No.: 09/395,166

(22) Filed: Sep. 14, 1999

Related U.S. Application Data
(63) Continuation of application No. 09/054,433, filed on Apr. 3, 1998.
Application No. 09/054,433 is a continuation-in-part of application No. 08/803,767, filed on Feb. 24, 1997, now Pat. No. 5,775,016.
Application No. 08/803,767 is a continuation-in-part of application No. 08/305,294, filed on Sep. 15, 1994, now Pat. No. 5,572,817.
Application No. 08/803,767 is a continuation-in-part of application No. 08/841,624, filed on Apr. 30, 1997, now abandoned.
Application No. 08/803,767 is a continuation-in-part of application No. 09/373,615, filed on Aug. 13, 1999, now abandoned.

(51) Int. Cl. B60Q 1/00

(52) U.S. Cl. 362/491

(57) ABSTRACT

A Illuminated Display for Transportation Equipment Shift assembly with super thin, flexible, colorful, Electro-luminescent Elements may selected from Organic type or Non-Organic type connected with circuit for predetermined light function to offer a illuminated display to driver for safety concern.

### BACKGROUND

This is a continuously for Co-Pending filing U.S. Pat. No. 09/054,433 which is a CIP filing of U.S. Pat. No. 5,775,016 filing on Jul. 3, 1995, which is a CIP filing for U.S. Pat. No. 5,572,817 filed on Sept. 15, 1994.

This also a Continuously for Co-Pending Filing uner U.S. Pat. No. 08/841,624 which filed on Apr. 3, 1997 and U.S. Pat. No. 09/373,615, filed Aug. 13, 1999.

The current invention improved a traditional incandescent light bulb illumination to EL (Electro-luminescent) Element(s).

The Current invention with a Non-Breakable, Long Life time, Flexible light, Multiple Color for choice, Selectable Lit-Area(s) arrangment EL element(s) for a light means so can improving the traditoion Bulb, LED light means including (1)Fragile quality of bulb, (2)Big Space such as mininum 10-20 mm long with 3-5 mm diameter to install blub or LED (3) Narrow Viewing angle for LED (4) Bulb have heat produce so need more space for ventilation (5) Bulb can not have surface light arrangement so need multiple piece to get some special design such as “L” Shape or “0” shape for a surface light (6) Bulb also have filament burn problem (7) LED have too narrow viewing angle so need multiple piece on a Printing circuit board to make all LED installation. However, all these problem can be solved by EL element(s).

The Current Invention incorporated the U.S. Pat. No. 5,572,817, U.S. Pat. No. 5,752,337, U.S. Pat. No. 5,794,366, U.S. Pat. No. 5,833,508 inventor's concept with “Selected lit-Area(s)” arrangement on EL elements with “Front Sheet with Positional Window” to allow the light to be visible. This application specified for the “Shift Location display” will offer the most practic1 application and mininum space need to allow car manufacture have the best light effects.

The Invention also improved the Multiple colors light required for “shift location Display” to increase driver safety attention. Only EL can have “selected lit-area(s)” arrangement using particle/layer arrangement of Phospher, conductive, dielectric material. This selected may including any combination including Position, Color, Size, Design, Terminals, Electrodes to get desired “SURFACE (Area) Photometric Effects” which LED and BULB can not do at all.

The Current Invention offered another simple assembly methord to allow to fit into the Dash Board, Plateform, Steering Wheel, Car Door, Console installation without need any complicated installation means needed, only need very small space approximately 2-4 mm height and desired shape space can install this EL elements . . .

Other Objects, features, and advantages of the invention will be apparent from the following detailed discription taken in connection with the accompnying drawings.

### DRAWING

FIG. 1: Disclosure the Shift Location Display for a Automatic Shift device.

FIG. 1-A: Disclosure the Shift Location Display for FIG. 1 but install on the Instrument Panel.

FIG. 2. Disclosure the Shift Location Display for a Hand Shift Model.

FIG. 2-A: Disclosure the Shift Location Display for FIG. (2) but install on Dash board surface.

FIG. 3: Disclosure the Shift Location Display For 1st Embordiments with EL element with Selected lit-area(s) and Front Sheet with window(s) with designs to allow the light to be visible. The EL element(s) with Cramp Terminal(s) to connected with Signal(s) End(s) by conductive means.

FIG. 4: Disclousure the Shift Location Display for 2nd Embodiment which is same as the FIG. 3 but EL Elements with the Contact Electrode(s) to connected with Circuit Board signal end(s) by conductive resilent member(s) to build the signal(s) delivery.

FIG. 5: Disclosure the another device which the Front Sheet Piece is a Plastic Housing with Window(s) to allow the EL element's lit-area(s) positioned and let light to be visible from such window(s).

FIG. 6: Disclosure the 3rd Embodiment for the preferable installation for EL element, Circuit unit, Power source, Housing with Window(s) for a shift device for transportation equipment.

FIG. 7: Disclosure the Display on instrument panel with detail compoments assembly methord for the FIG. (1-A) display.

FIG. 8: Dislosure the Display on Dash panel surface with compoments assembly methord for FIG. (2-A) display.

FIG. 9: Disclosure The shift location display on the shift Handle Bar with details assembly methord with compoments.

FIG. 10: Disclosure the Shift Location Display Device for this invention inside the transportation Equipment

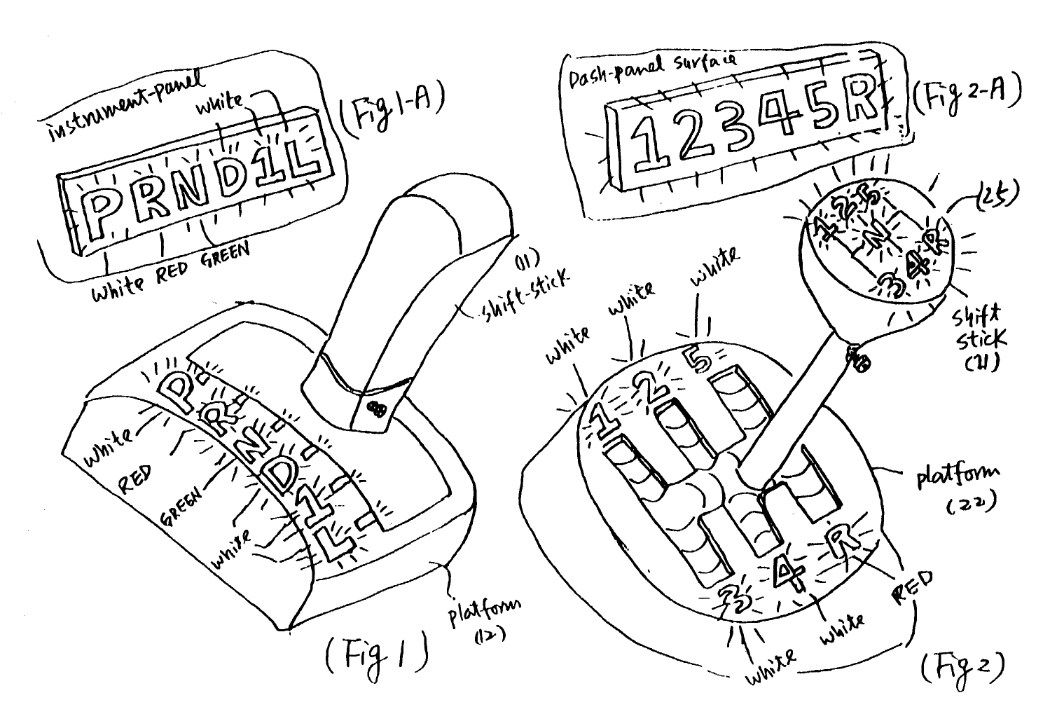

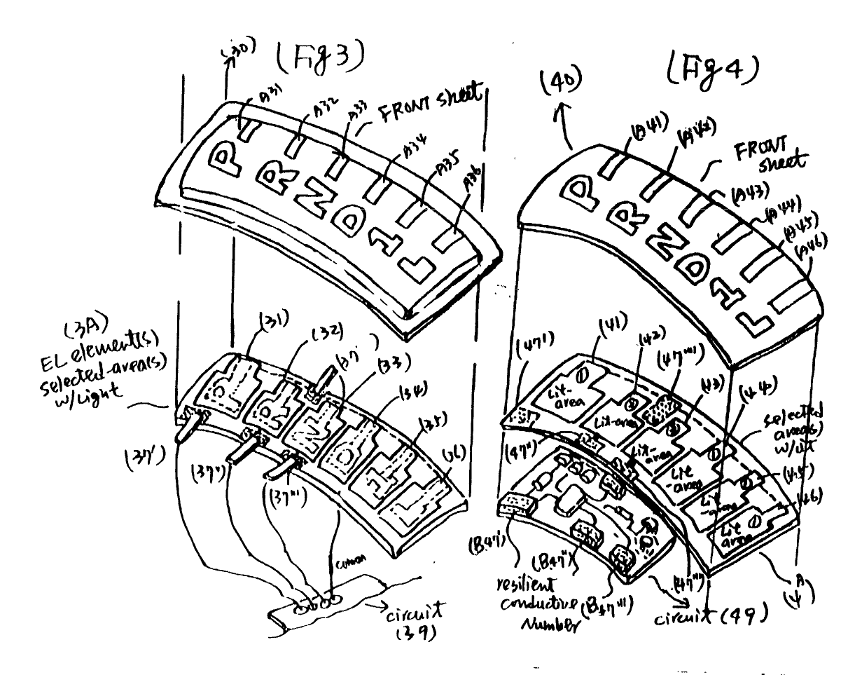

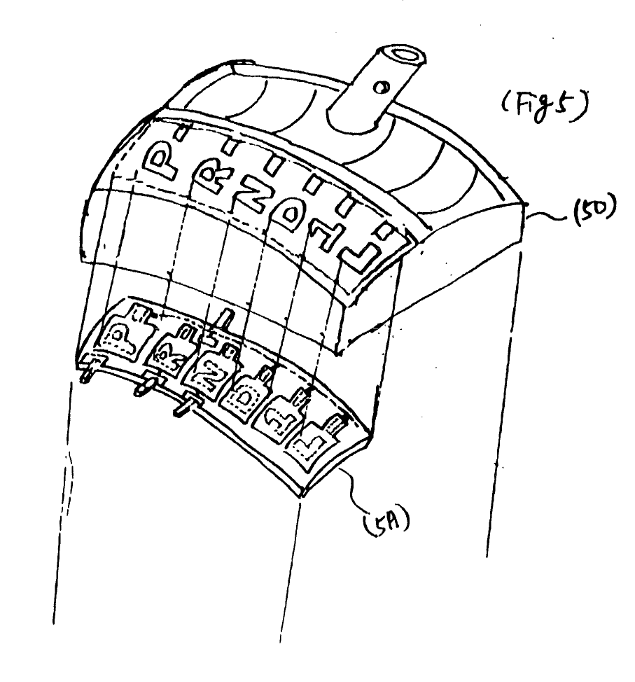

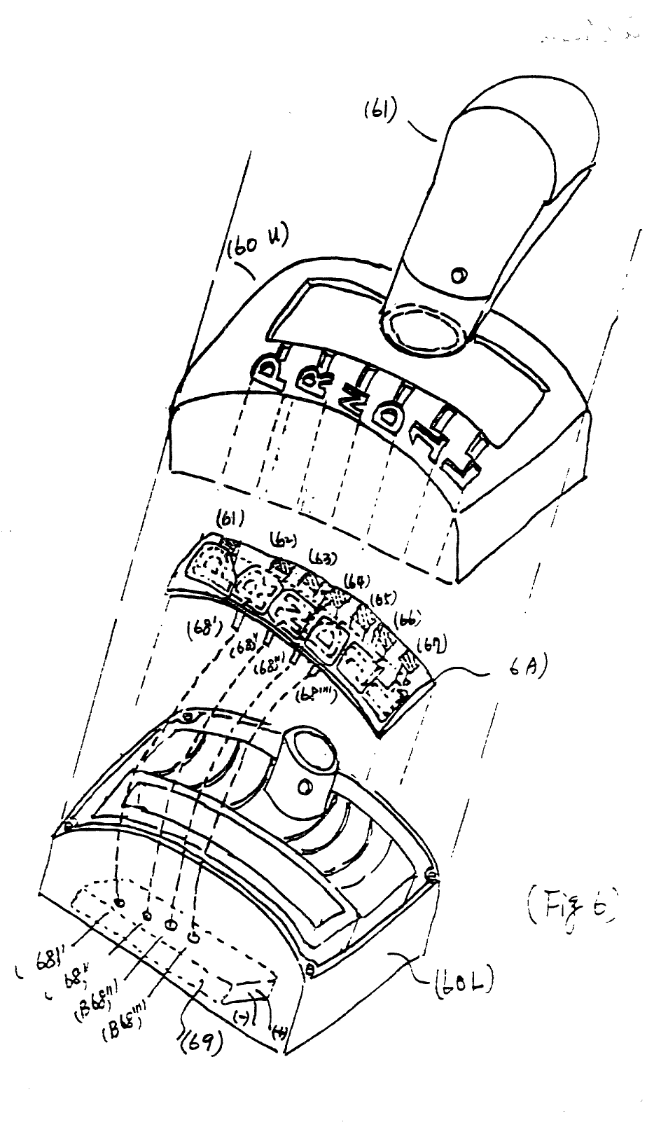

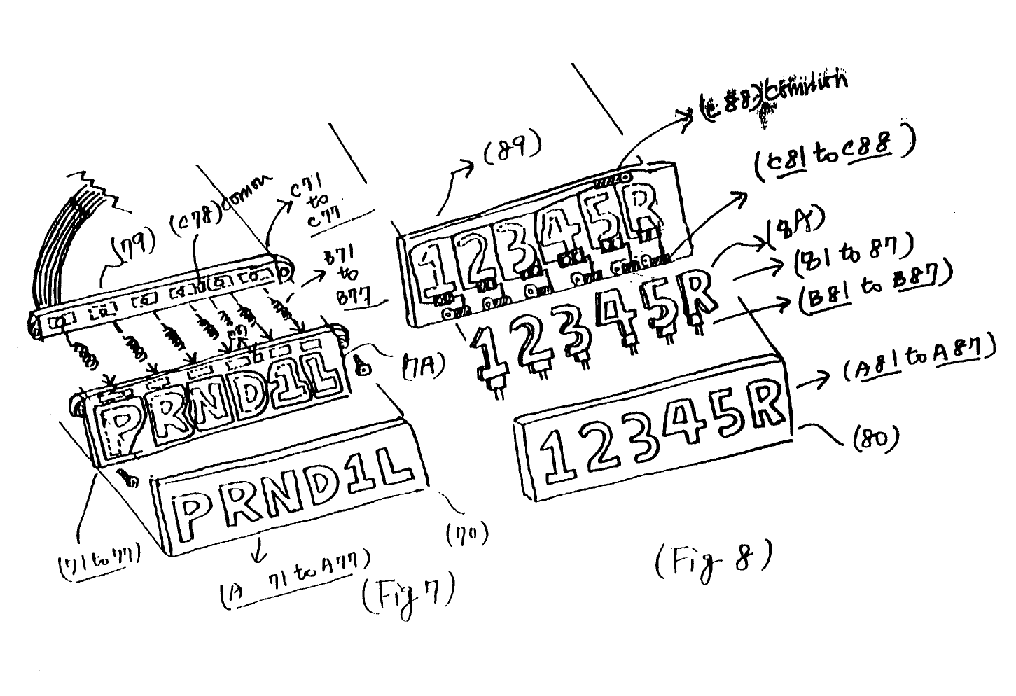

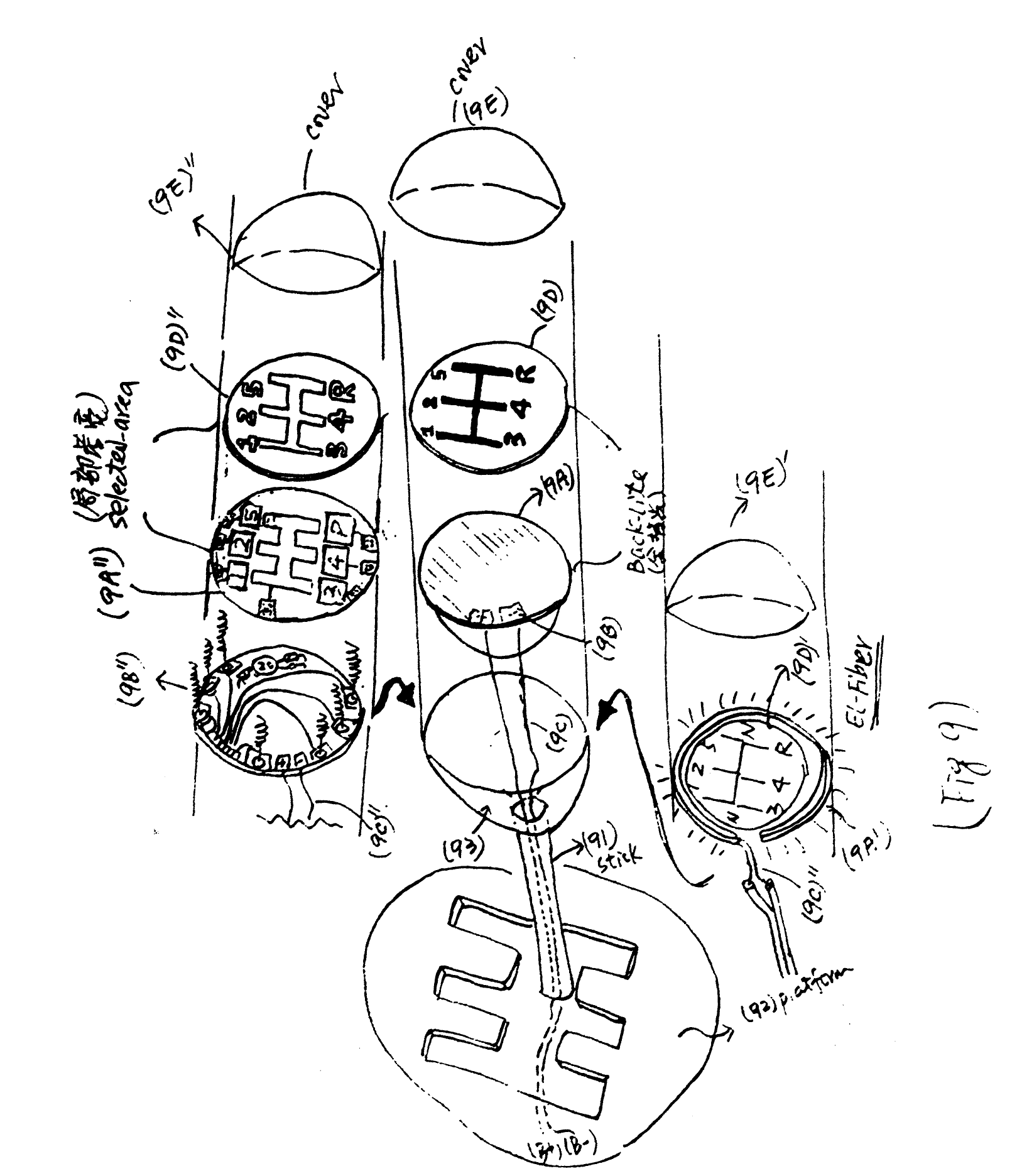

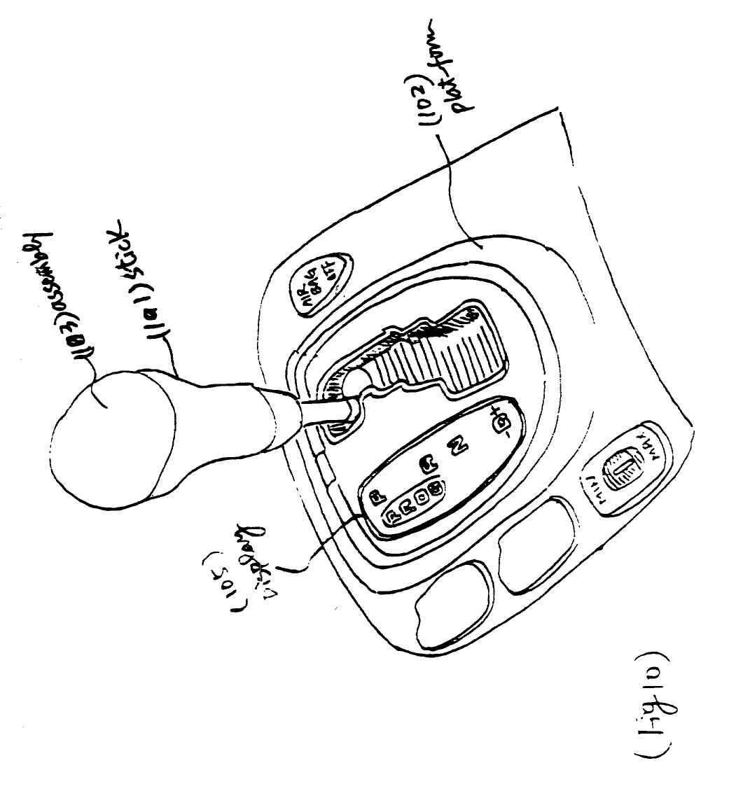

The features of this invention which are believed to be novel are set forth with particularity in the appended claims. The invention, togather with its objets and the advantaes thereof, may be best understood by reference to the following description taken in conjunction with the accompanying drawings, in which like rererence numerals identify like elements in the figures and in which:

### DETAIL DESCRIPTION

From (1) disclosure the Shift assembly, including Shift-stick (11) on a Plateform(12) basis. The illuminated “P R N D L 1” can be visible from the Plateform's window(s). The FIG. (l-A) is the 2nd shift-location display which are installed on the “instrument panel” for better viewing without bending head to lower position.

From FIG. (2) disclosure the “Shift Assembly” for the Hand-shift model which have shift stick (21) on the platform (22) with illuminated display connected with “Driving lamp” system to offer illumination to driver. The hand-shift with “1 2 3 4 5 R” on each position and also can install on the Shift head (25).

FIG. (2-A) show the same display “1 2 3 4 5 R” on the dash panel surface as market required. FIG. (3) show the features of a “selected lit-area(s)” (31) (32) (33) (34) (35) (36) (37) on a single piece of EL element (3A) with pre-arranged wiring by partical(s) arrangement within the layers of phospher, dielectric, conductive materail arrangement. The preferable number of terminal(s) (37′) (37″) (37″′) to connected with certain number of Lit-Area(s) with a common terminal (37″″) using electric conductive means maybe in a wire-constructure to connect with the Signal-End(s) of the circuit board (39). The Each Lit-Area(s) (31 to 36) are position to the window(s) (A31 to A36) to allow the lit-area(s) to be seen from these window(s) (A31 to A36) of the front-Sheet (30) which may use the material selected from the group consideration including Plastic, Wood, Textile, Paper, Metal, Rubber, Poceline, or other conventional material in a certain configuration. The Front-Sheet (30) may use conventional technical to make the window(s) by Stencil, Silkscreen, Cut-Out, Laser Cutting of Lamination sheets, Opening, Filter, or other process to get the DESIGN, INDICIA, NUMBER, WORDING, on this Front-Sheet (30) device.

From FIG. (4) can see the same constructure with FIG.(3) but the 6 lit-area(s) in a group arrangement such as Group A have lit-area(s) (41) (44) (45) (46) for “P D 1 L ” connected with one common contact-electrode (47″″) with 1st color such as “GREEN”, Group B have lit-area(s) (42) for “R” with 2nd color such as “RED”. connected with contact-electrode (47″) . The Group C have lit-area have (43) with 3rd color for “N” connected with contact-electrode (B47″′). The contact-electrode(s) (47′) (47″) (47″′) (47″″) on the EL Element (4A) with a common electrode for connect with signal-End from circuit (49) by the CONDUCTIVE RESILIENT MEANS (B47′) (B47″) (B47″′) (B47″″) which may selected from the Metal Spring, Conductive Rubber, Metal Plate to build the electric connections between the EL electrodeS to Signal-EndS. It also can be in the form from FIG. (3) use the Conductive Means such as Wire Harness with or without the quickly connector device or the equivelent device from market place to build the electricity delivery purpose.

From FIG. (5) disclosure the whole illuminted shift location display with a SHIFT STICK (61), Cover for platform (60U) with variety Window(s) in the form of “P R N D 1 L ” which is have certain degress light passing though capability so allow the Variety positioned Lit-areas such as (61) (62) (63) (64) (65) (66) can be emitt the light though these windows to be visible from outside. A Base of Plateform (60L) to assembly with (60U) cover to hold the PROPER CIRCUIT (69) which according to use a Orgranic EL elements or Non-Organic EL elemnts. For example while using a Organic EL Element(s) which can operated by Direct Current (DC) Signals from the circuit (69). However, While It use a “Non-Organic EL element” which need a AC (Alternatic Current Form with certain Voltage and Frequency) to trigger the non-organic EL elements. The Invertor system can use Inductor or Transformer with proper compoments to get the desired voltage and frequency from Car Battery Power source to make the predetermined light effects. The illuminated Display system may connect with Transportation Lighting System to save the Day time power consumption. The most popular connection is to the Transportation Driving Light System, so long as the Car's Driving Light is Turn on, This display will] turn on too. Hence, The Proper Switch System is incorporated with This Illumination Display, however, It is not limited to the Driving Light, It also can incorporated with “Daytime Headlighting System” which some country have law requirement such as Canada. It also can incorporated with other switch sytem may selected from group consideration such as Dimmer Swtich, Photo Sensor device, or other Machenical or Electric Switch or Sensor units with desried controlling the illumination timing. However, All such switching system can also inside the Circuit Box (69) for better enviroment protection which may sealed by Epoxy chemical or Silicon or other material to prevent circuit's compments be rusted or broken or oxyde.

The FIG. (7) disclosure the “FIG. (1-A) display on instrument panel” which have the Front-Sheet (70) with A single piece EL panel (7A) with a 6 selected lit-areas with “Area light photometric with desire size and shape” (71 to 77) which positioned behind the Front Sheet (70) Windows (A71 to A77) with its cotact-electrods to connected with the Conductive Resilent Material in Sping Form (B71-77) with a extra common electrod (78) to connected with the respectly signal-ends (C71 to 77) and common signal-end (C78). The (79) connect with circuit (not show) by conductive wire or Pin or Socket set so get the Signals to turn on the Display under perdetermined light effects.

FIG. (8) show the equivelent device with FIG. (7) but the EL-panel (8A) is not a SINGLE Piece and it also without the Pre-Wired for each Single EL element(s). The each EL element (B81 to B87) have its terminal (B81 to B87) connected with a Pre-Wired Printing circuit Board (89) which maybe in a Plastic sheet type with Silver paste silkscreen or a Print Circuit Board which is made by traditonal Board with Itching Surface to get electric Copper wiring for Diagram. For examples this embordiment can use a Crimp terminal (B81 to B87) to solering on the Printing circuit Board (89) and position on with the “Donductive means—Cooper wiring” to make electric connection for total (81 to 87) for illumination for desired purpose.

From FIG. (9), Disclosure the illumiation for other place installtion such as for the “Shift stick Knob”. The 3 equivelent methord apply with common parts A Shift stick (91) with a proper conductive means (9C) (9C′) (9c″) connected with Board (9b) (9b″) (9B″′) which maybe as (9b″) which is the Printing circuit board to drive a non-Organic EL element(s) so with IC Chip, Electric compments, Pre-wiring and some invertor device to drive the input power to a desired EL trigger current form. From Board (9B) can see without any electric compoments and only have electrode to hook with wire which means this is a typical Organic EL elements which no need any AC current and can drive from the Car DC power source with prefereable voltage. The (9B′) is same as (9B″) with a lot of compoments to drive the Non-Organice EL elememtns which is a EL-Fiber which same as Co-Pending filing patent 08/758,393 with 360 degree illumination so can turn whole knob be visible well and the light emitted to the Indicia, Design, Logo, Mark so be visible at the Night Time for Shift location. Each model also have proper “Window or Stencil” on (9D) (9D″) (9D′) with a cover (9E) (9E′) (9E″) for a shift knob illumiation for the display . . .

FIG. (10) is a details drawing for this invention.

* The FULL DISCLOSURE & THE ABOVED (6)U.S. PATETNS ARE INCORPERATED HEREIN BY REFERENCE.

** While The invention has been described, disclosed, illustrated and shown in arious terms or certain embodiments or modifications which it has assumed in practicce, the scope of the invention is not intended to be, nor should it be deemed to be, limited thereby and such other modifications or embodiments as may be suggested by the teaching herein are particularly reserved especially as they fall within the breadth and scope of the claims here appended.

I claim:

1. A Illuminated Shift Display with Electro-luminescent element(s) incorporated:
A Electro-luminescent Element having Selected lit-area(s)
A Front-Device with Window(s)
A Circuit to offer Signal(s) to Electro-Luminescent Element to Trigger Element(s) to turn on light to be visible for predetermined function(s)
The Improvement including:
The Window(s) position to Lit-Area(s) with installation means to make such Position properly.

2. The Illuminted Shift Display as claim 1 , The Window(s) and Lit-Area(s) may have design on it may selected group consideration by Silkscreen, Stencil, Masking, Filter, Overlay process.

3. The Illumination Shift Display as claim 1 , The Elements is a Organic type which operated by Direct Current.

4. The Illumination Shift Display as claim 1 , the Element is a non-organic type need have Aleternative Current to trigger.

5. The Illumiated Shift Display as claim 1 , Display can install on anywhere of interior of transportation equipment.

6. The Illumiated shift Display as claim 1, Circuit may incorporated any combinatin of controlling system selected from Mecanical, Electric Switch, Sensor, Detetor.

7. The Illuminted Shift Display as claim 1, incorporated Power Source is a DC battery.
